(19) United States
(12) Patent Application Publication
(10) Pub. No.: US 2005/0064216 A1
(43) Pub. Date: Mar. 24, 2005

(54) Thermosetting laminating resin composition

(76) Inventors: Lixin Jin, Raleigh, NC (US); Hildeberto Nava, Cary, NC (US)

Correspondence Address: MYERS BIGEL SIBLEY & SAJOVEC, PO BOX 37428, RALEIGH, NC, 27627, US

(21) Appl. No.: 10/946,599

(22) Filed: Sep. 21, 2004

Related U.S. Application Data
(60) Provisional application No. 60/504,787, filed on Sep. 22, 2003.

(51) Int. Cl. B32B 27/36; C08L 67/00

(52) U.S. Cl. 428/480; 525/440; 525/445; 525/437

(57) ABSTRACT

The present invention provides a thermosetting resin composition based on an orthophthalic unsaturated polymer resin, a dicyclopentadiene (DCPD) resin and a polyether urethane acrylate having two or more acrylate functionality per molecule.

### CROSS-REFERENCE TO RELATED APPLICATIONS

This application claims the benefit of, and incorporates herein by reference in its entirety, the following U.S. Provisional Application: U.S. Provisional Application No. 60/504,787, filed Sep. 22, 2003.

### FIELD OF THE INVENTION

The present invention generally relates to thermosetting resins, and more particularly to thermosetting resin compositions for use in laminating applications for reinforcing thermoplastic substrates, particularly acrylic and/or ABS thermoplastic substrates.

### BACKGROUND OF THE INVENTION

Thermoplastics are materials with a wide range of properties that may be applied in a variety of areas and applications. These materials, however, may have some disadvantages, for example, low heat distortion temperature and poor mechanical properties. Moreover, there is a need for thermoplastics to withstand high forces under tension, flexural and compression conditions. These properties are often not possible to achieve due to the poor mechanical properties resulting from low elongation making the materials rigid and brittle. To eliminate these problems, it is often necessary to reinforce the thermoplastic substrates with thermosetting polymer systems. The thermoplastic materials when on tension or compression can transfer the load onto the reinforced thermosetting compositions preventing rupture of the substrate under load. In order for the thermosetting system to function as reinforcement, it is necessary to have an excellent adhesion to the substrate. The interface adhesion between a thermoplastic and a thermosetting system is important in that mechanical forces should be equally distributed to prevent any damage on the composite structures. For example, reinforced thermoplastic sheets for bathroom fixtures (e.g., bathtubs, whirlpool tubs and kitchen fixtures) are exposed repetively to the normal hot and cold conditions of bath water. Lack of adhesion can make the thin thermoplastic sheet vulnerable to hydrolysis attack and the resulting blistering, blushing, cracking and the like.

The thermosetting composition reinforcement should possess excellent adhesion and hardness once fully cured. Due to the significant increase of viscosity as a result of the fillers, it is a challenge to do so without using large amounts of styrene. The use of large amounts of styrene should be avoided due to environmental regulations that require styrene levels to be controlled to minimize styrene vapor emission to the atmosphere.

Various thermosetting laminating resin compositions have been proposed in the art. For example, Japanese Patent No. JP11216075, describes the preparation of resin compositions to reinforced bathtubs made from acrylic thermoplastics. The thermoplastic is first coated with a primer layer followed by a polyurethane resin layer as the reinforcement. Japanese Patent No. JP9110952 describes the thermosetting resins with good adhesion to acrylic thermoplastics. The thermosetting resin compositions comprise: an unsaturated polyester and epoxy acrylate. World Patent No. WO91/17040 proposes polyester backed acrylic composite molding structures. The patent proposes the use of unsaturated polyesters, vinyl esters, epoxy and acrylic resins. A thermoplastic shell is bonded to the fiber reinforcement layer by a silane based primer and a methacrylate. U.S. Pat. No. 6,613,444, describes reinforcing bathtubs or shower trays. The patent proposes the use of polymethyl methacrylate thermoplastic dissolved in polyfunctional acrylates and glass microballoons that spray onto the thermoplastic substrate to reinforce it. U.S. Pat. No. 6,211,259 proposes a thermosetting composition to reinforce acrylic thermoplastic. The patent discloses a low volatile reinforcing system that comprises a polyol, an isocyanate and filler that are sprayed unto thermoformed acrylic thermoplastic. U.S. Pat. No. 3,720,540 describes production of glass fiber reinforced plastics articles such as bathtubs. The patent proposes sprayable mixtures of a thermosetting unsaturated polyester resin and a bond-improving additive consisting of styrene monomer. Total styrene monomer in the compositions can be as high as 80% by weight.

There, however, remains a need in the art for a more stable thermosetting composition that can have excellent adhesion to thermoplastic substrates, particularly those containing acrylic materials. Further, there is a need for a laminating resin that employs a reduced level of ethylenically unsaturated monomers (e.g., styrene) while displaying a desirable range of physical properties, particularly with respect to strength and adhesion to the thermoplastic substrate.

### SUMMARY OF THE INVENTION

In response to the above needs and others, the present invention provides a thermosetting resin composition based on an orthophthalic unsaturated polymer resin, a dicyclopentadiene (DCPD) resin and a polyether urethane acrylate having two or more acrylate functionality per molecule. Although an ethylenically unsaturated monomer can be used, no greater than about 40 percent by weight of ethylenically unsaturated monomer can be used while providing excellent physical properties particularly with respect to strength, toughness, and adhesion, particularly to acrylic and ABS thermoplastic sheet.

In other embodiments of the present invention, the thermosetting composition comprises at least one chain-stopped orthophthalic unsaturated polyester resin, at least one dicyclopentadiene unsaturated polyester resin, and at least one polyether urethane acrylate. Fillers, colorants, and other additives may be added to the thermosetting composition as desired.

The invention also provides an article of manufacture. The article of manufacture comprises the thermosetting resin composition described above, a fibrous reinforcement, and a thermoplastic substrate, such as an acrylic or ABS thermoplastic sheet.

### DETAILED DESCRIPTION OF EMBODIMENTS OF THE INVENTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

According to some embodiments, the invention relates to a polyester-based or polyester-containing laminating resin composition. The laminating resin composition exhibits improved adhesion to thermoplastic sheets, and particularly acrylic and ABS thermoplastic sheets. For the purposes of the invention, the term “adhesion” may be defined according to various measuring methods. In one instance, the adhesion may be defined by the term “tensile adhesion” by ASTM C297 method, standard test method for flatwise tensile strength of sandwich constructions. “tensile adhesion” refers to the tensile force necessary for the rupture of reinforced thermosetting resin laminate from the acrylic and ABS thermoplastic substrates. A preferred tensile adhesion is greater than about 1300 psi, more preferably greater than about 1400 psi and most preferably greater than about 1450 psi. When the tensile adhesion is greater than 1300 psi, the thermosetting resin laminate will start to rupture and fail within the laminate rather than the interface of laminate and thermoplastic sheets, indicating adequate adhesion of the laminate to the acrylic and ABS thermoplastic substrate.

Specifically, the laminating resin composition comprises an orthophthalic unsaturated polyester resin, a dicyclopentadiene (DCPD) resin and a polyether urethane acrylate oligomer. In other embodiments, the thermosetting composition may comprise at least one chain-stopped orthophthalic unsaturated polyester resin, at least one DCPD unsaturated polyester resin, and at least one polyether urethane acrylate. The laminating resin composition is thermosettable. The components of the laminating resin composition may be present in the form of a blend or mixture.

Any number of orthophthalic unsaturated polyester resins may be used in the composition of the invention. Examples of unsaturated polyester resins and methods of making these materials are set forth, for example, in U.S. Pat. Nos. 5,118,783; 6,348,270 B1; WO 00/23495; WO 0023521, the disclosures of which are incorporated herein by reference in their entirety. In accordance with embodiments of the present invention, low molecular weight unsaturated polyesters are prepared by the condensation of dicarboxylic acid or anhydrides with polyhydric alcohols in the presence of chain-stopping monoalcohols or monofuctional acids. Preferably, the unsaturated polyester resin has a Mₙ of less than 1500.

Suitable dicarboxylic acids or anhydrides include adipic acid, phthalic acid, phthalic anhydride, terephthalic acid, isophthalic acid, hexahydrophthalic acid, hexahydrophthalic anhydride, trimelitic acid, trimelitic anhydride, maleic acid, maleic anhydride, fumaric acid, and the like, and mixtures thereof.

Suitable polyhydric alcohols include ethylene glycol, propylene glycol, diethylene glycol, dipropylene glycol, trimethylolpropane, trimethylol ethane, neopentyl glycol, pentaerythritol, glycerine, triethylene glycol, cyclohexane dimethanol, hexane diol, butylenes glycol, and the like, and mixtures thereof.

Anhydrides that can be employed in the making of a polyester are preferably cyclic or acyclic, saturated or unsaturated. In a “cyclic” anhydride, the anhydride functionality is contained within a ring, such as in phthalic anhydride and maleic anhydride. “Saturated” anhydrides contain no ethylenic unsaturation, although they may contain aromatic rings. Phthalic anhydride, propionic anhydride, and succinic anhydride are examples of saturated anhydrides. “Unsaturated” anhydrides contain ethylenic unsaturation. This unsaturation typically becomes incorporated into the polyetherester, and can be used for crosslinking. Examples include maleic anhydride, itaconic anhydride, and the like.

Specific examples of suitable anhydrides include, but are not limited to, acetic anhydride, propionic anhydride, maleic anhydride, phthalic anhydride, succinic anhydride, tetrahydrophthalic anhydride, citraconic anhydride, itaconic anhydride, and aryl-, alkyl-, and halogen-substituted derivatives of the above. Mixtures of these anhydrides may be used. The selection of the amounts of polyether and anhydride that may be used can be determined by the end user, and may depend, for example, upon the types of physical properties or degree of crosslinking that is desired.

The monofunctional chain-stopping acids and alcohols do not contain ethylenic unsaturation and include benzyl alcohol, benzoic acid, cyclohexanol, 2-ethyl hexanol, and the like, and mixtures thereof. When a monofunctional acid is used, a terminal hydroxyl group of the polyester is removed and replaced with a hydrocarbon group. When a monofunctional alcohol is used, a terminal carboxy group of the polyester is removed and replaced with a hydrocarbon group.

The carboxylic acids or anhydrides are generally used in amounts varying from about 50 to 98 mole percent, preferably from about 80 to 95 mole percent and more preferably, from about 85 to 95 mole percent of the total acid composition. The polyhydric alcohols are generally used in amounts varying from about 100 to 225 mole percent, preferably from about 105 to 140 and more preferably from about 110 to 125 mole percent of the total acid composition. Monofunctional chain-stopping materials can generally be used in amounts varying from 2 to 50 mole percent of the total acid or total polyhydric alcohols, preferably from about 5 to 30 mole percent, and more preferably from about 5 to 20 mole percent. The total acid comprises the first group of acids or anhydrides used to form the unsaturated polyester and the second group of acids or corresponding alcohols used to perform the chain stop operation. To obtain a chain-stopping effect, the functionality of the chain-stopper must be less than two. If the functionality is 2 or greater, the polymer chain can extend in both directions, and there is no chain stopping effect. When the functionality is less than 2, the polymer cannot propagate in both directions, thereby effectuating the chain stopping effect.

The thermosetting resin composition may comprise various levels of polyester resin. Preferably, the thermosetting resin composition comprises from about 10 to about 80 percent by weight of the unsaturated polyester resin, and more preferably from about 20 to about 50 percent by weight.

The thermosetting resin composition includes a DCPD resin. DCPD resins used in the composition of the invention are known to those skilled in the art. These resins are typically DCPD polyester resins and derivatives which may be made according to various accepted procedures. As an example, these resins may be made by reacting DCPD, ethylenically unsaturated dicarboxylic acids, and compounds having two groups wherein each contains a reactive hydrogen atom that is reactive with carboxylic acid groups (e.g., a polyol). DCPD resins made from DCPD, maleic anhydride phthalic anhydride, isophthalic acid, terephthalic acid, adipic acid, water, and a glycol such as, but not limited to, ethylene glycol, propylene glycol, diethylene glycol, neopentyl glycol, dipropylene glycol, and poly-tetramethylene glycol, are particularly preferred for the purposes of the invention. The DCPD resin may also include nadic acid ester segments that may be prepared in-situ from the reaction of pentadiene and maleic anhydride or added in its anhydride form during the preparation of the polyester. The preparation of DCPD resins is described, for example, in U.S. Pat. Nos. 3,933,757, 3,347,806, 3,883,612, and 4,029,848, the disclosures of which are incorporated herein by reference in their entirety.

The DCPD resin may be used in various amounts in the laminating resin composition of the invention. Preferably, the laminating resin composition comprises from about 10 to about 80 weight percent of DCPD resin, and more preferably from about 20 to about 40 weight percent. Preferably, the DCPD resin has a number average molecular weight ranging from about 450 to about 1500, and more preferably from about 500 to about 1000. Additionally, the DCPD resin preferably has an ethylenically unsaturated monomer content of below 35 percent at an application viscosity of 500 cps.

Polyethers for the preparation of urethane acrylates suitable for use with embodiments of the invention are preferably those derived from the base or acid-catalyzed ring-opening polymerization of cyclic ethers such as epoxides, oxetanes, oxolanes, tetrathydrofuran and the like. The polyethers have repeat units of oxyalkylene groups (—O-A-) in which A preferably has from 2 to 10 carbon atoms, more preferably 2 to 6 carbon atoms, and most preferably 2 4 carbon atoms. The polyethers can have different end groups, depending upon how the polyethers are made or modified. For example, the polyether can have hydroxyl, ester, ether acid, olefinic, or amino end groups, or the like, or combinations of these. Mixtures of different types of polyethers can be used. The polyethers may be branched, containing a number of branches from 2 to 10, preferably 2 to 5 and most preferably 2 to 3. Preferred polyether end groups are hydroxyl and amino end groups. The end groups may be reacted with an isocyanate and a hydroxyl alkyl or hydroxyl alky aryl (meth)acrylate. The (meth)acrylate groups are positioned as terminal or pendant along the backbone of the polyether. Preferably the polyether urethane acrylate has an acrylate functionality of two or more. Preferred polyethers are polyether polyols. Examples of polyether polyols include, but are not limited to, polyoxypropylene polyols, polyoxyethylene polyols, ethylene oxide-propylene oxide copolymers, polytetramethylene ether glycols, oxetane polyols, and copolymers of tetrahydrofuran and epoxides. Typically, these polyols with have average hydroxyl functionalities of from about 2 to about 8.

Preferably the thermosetting resin composition comprises from about 0.3 to about 10 percent by weight of the polyether urethane acrylate, and more preferably from about 1 to 5 percent by weight.

In the event that the laminating resin composition employs an ethylenically unsaturated monomer such as, for example, a vinyl monomer, the laminating resin preferably comprises less than about 40 percent by weight of such monomer. Employing less than 40 percent by weight of such a monomer may be potentially advantageous from an environmental standpoint relative to conventional resins. As known, the potential risk of any monomer often depends on various processing conditions relating to, for example, temperature, pressure, and monomer concentration. As an example, OSHA has suggested an allowable 8 hours time weight average styrene exposure level of 50 ppm. Ethylenically unsaturated monomers that may be included as a diluent, reactant, co-reactant or may be post added once the polymerization of the desired polymer and/or oligomer was completed, and may include those such as, for example, styrene and styrene derivatives such as ÿ-methyl styrene, p-methyl styrene, divinyl benzene, divinyl toluene, ethyl styrene, vinyl toluene, tert-butyl styrene, monochloro styrenes, dichloro styrenes, vinyl benzyl chloride, fluorostyrenes, tribromostyrenes, tetrabromostyrenes, and alkoxystyrenes (e.g., paramethoxy styrene). Other monomers which may be used include, 2-vinyl pyridine, 6-vinyl pyridine, 2-vinyl pyrrole, 2-vinyl pyrrole, 5-vinyl pyrrole, 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxozole, 3-vinyl isothiazole, 2-vinyl pyrimidine, 4- vinyl pyrimidine, 6-vinyl pyrimidine, any vinyl pyrazine. Classes of other vinyl monomers also include, but are not limited to, (meth)acrylates, vinyl aromatic monomers, vinyl halides and vinyl esters of carboxylic acids. As is used herein and in the claims, by “(meth)acrylate and the like terms is meant both (meth)acrylates and acrylates. Examples include but are not limited to oxyranyl (meth)acrylates like 2,3-epoxybutyl (meth)acrylate, 3,4-epoxybutyl (meth)acrylate, 10,11 epoxyundecyl (meth)acrylate, 2,3-epoxycyclohexyl (meth)acrylate, glycidyl (meth)acrylate, hydroxyalkyl (meth) acrylates like 3-hydroxypropyl (meth)acrylate, 2-hydroxyethyl (meth) acrylate, 2,5-dimethyl-1,6-hexanediol (meth)acrylate, 1,10-decanediol (meth)acrylate, aminoalkyl (meth)acrylates like N-(3-dimethylaminopentyl (meth)acrylate, 3-dibutylaminohexadecyl (meth)acrylate; (meth)acrylic acid, nitriles of (meth)acrylic acid and other nitrogen containing (meth)acrylates like N-((meth)acryloyloxyethyl)diisobutylketimine, N-((meth)acryloylethoxyethyl)dihexadecylketimine, (meth)acryloylamidoacetonitrile, 2-(meth)acryloxyethylmethylcyanamide, cyanoethyl (meth)acrylate, aryl (meth)acrylates like benzyl (meth)acrylate or phenyl (meth)acrylate, where the acryl residue in each case can be unsubstituted or substituted up to four times; carbonyl-containing (meth)acrylates like 2-carboxyethyl (meth)acrylate, carboxymethyl (meth)acrylate, oxazolidinylethyl (meth)acrylate, N-((meth)acryloyloxy) formamide, acetonyl (meth)acrylate, N-(meth)acryloylmorpholine, N-(meth)acryloyl-2-pyrrolidinone, N-(2-(meth)acryloxyoxyethyl)-2-pyrrolidinone, N-(3-(meth)acryloyloxypropyl)-2-pyrrolidinone, N-(2-(meth)ylacryloyloxypentadecenyl)-2-pyrrolidinone, N-(3-(meth)acryloyloxyheptadecenyl)-2-pyrrolidinone; (meth)acrylates of ether alcohols like tetrahydrofurfuryl (meth)acrylate, vinyloxyethoxyethyl (meth)acrylate, methoxyethoxyethyl (meth)acrylate, 1-butoxypropyl (meth)acrylate, 1-methyl-(2-vinyloxy)ethyl (meth)acrylate, cyclohexyloxymethyl (meth)acrylate, methoxymethoxyethyl (meth)acrylate, bezyloxymethyl (meth)acrylate, furfuryl (meth)acrylate, 2-butoxyethyl (meth)acrylate, 2-ethoxyethoxymethyl (meth)acrylate, 2-ethoxyethyl (meth)acrylate, allyloxymethyl (meth)acrylate, 1-ethoxybutyl (meth)acrylate, ethoxymethyl(meth)acrylate; (meth)acrylates of halogenated alcohols, like 2,3-dibromopropyl (meth)acrylate, 4-bromophenyl (meth)acrylate 1,3-dichloro-2-propyl (meth)acrylate, 2-bromoethyl (meth)acrylate, 2-iodoethyl (meth)acrylate, chloromethyl (meth)acrylate; phosphorus-, boron, and/or silicon-containing (meth)acrylates like 2-(dimethylphosphato)propyl (meth)acrylate, 2-(ethylphosphito)propyl (meth)acrylate, dimethylphosphinoethyl (meth)acrylate, dimethylphosphinomethyl (meth)acrylate, dimethylphosphonoethyl (meth)acrylate, dimethy(meth)acryloyl phosphonate, dipropyl(meth)acryloyl phosphate, 2-(dibutylphosphono)ethyl methacrylate, 2,3-butelene(meth)acryloylethyl borate, methyldiethoxy(meth)acryloylethoxysilane, diethylphospahtoethyl (meth)acrylate; sulfur-containing (meth)acrylates like ethylsulfinylethyl (meth)acrylate, 4-thiocyanatobutyl (meth)acrylate, ethylsulfonylethyl (meth)acrylate, thiocyanathomethyl (meth)acrylate, methylsulfonylmethyl (meth)acrylate, bis((meth)acryloyloxyethyl) sulfide.

Suitable polyfunctional acrylate may be used in the resin composition, including those described, for example, in U.S. Pat. No. 5,925,409 to Nava, the disclosure of which is incorporated by reference herein in its entirety. Such compounds include, but are not limited to, ethylene glycol (EG) dimethacrylate, butanediol demethacrylate, and the like. The polyfunctional acrylate which may be used in the present invention can be represented by the general formula: 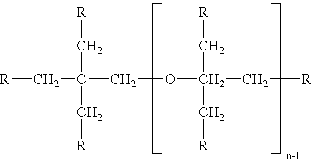
wherein at least four of the represented R's present are (meth)acryloxy groups, with the remainder of the R's being an organic group except (meth)acryloxy groups, and n is an integer from 1 to 5. Examples of polyfunctional acrylates include ethoxylated trimethyolpropane triacrylate, trimethyolpropane tri(meth)acrylate, trimethyolpropane triacrylate, trimethylolmethane tetra(meth)acrylate, pentaerythritol tetra(meth)acrylate, dipentaerythritol tetra(meth) acrylate, dipentaerythritol penta(meth)acrylate, and dipentaerythritol hexa(meth)acrylate; heterocyclic (meth)acrylates like 2-(1-imidazolyl)ethyl (meth)acrylate, 2-(4-morpholyl)ethyl (meth)acrylate and 1-(2-(meth)acryloyloxyethyl)-2-pyrrolidinone; vinylhalides such as vinyl chloride, vinyl fluoride, vinylidene chloride and vinylidene fluoride; vinyl esters like vinyl acetate, vinyl butyrate, vinyl 3,4-dimethoxybenzoate, vinyl benzoate and isoprenyl esters; maleic acid and maleic acid derivatives such as mono and diesters of maleic acid, maleic anhydride, methyl maliec anhydride, methylmaleimide; fumaric and fumaric acid derivatives such as mono and diesters of fumaric acid.

The optional addition of fiber(s) provide a means for reinforcing, strengthening or stiffening the polymerized cured composition. The types often used are:

Inorganic crystals or polymers, e.g., fibrous glass, quartz fibers, silica fibers, fibrous ceramics, e.g., alumina-silica (refractory ceramic fibers); boron fibers, silicon carbide, silicon carbide whiskers or monofilament, metal oxide fibers, including alumina-boria-silica, alumina-chromia-silica, zirconia-silica, and others;

Organic polymer fibers, e.g., fibrous carbon, fibrous graphite, acetates, acrylics (including acrylonitrile), aliphatic polyamides (e.g. nylon), aromatic polyamides, olefins (e.g., polypropylenes, polyesters, ultrahigh molecular weight polyethylenes), polyurethanes (e.g., Spandex), alpha-cellulose, cellulose, regenerated cellulose (e.g., rayon), jutes, sisal, vinyl chlorides , vinylidenes, flax, and thermoplastic fibers;

Metal fibers, e.g., aluminum, boron, bronze, chromium, nickel, stainless steel, titanium or their alloys; and “whiskers”, single, inorganic crystals.

Suitable filler(s) non-fibrous are inert, particulate additives being essentially a means of reducing the cost of the final product while often reducing some of the physical properties of the polymerized cured compound. Fillers used in the invention include calcium carbonate of various form and origins, silica of various forms and origins, silicates, silicon dioxides of various forms and origins, clays of various forms and origins, feldspar, kaolin, flax, zirconia, calcium sulfates, micas, talcs, wood in various forms, glass(milled, platelets, spheres, micro-balloons), plastics (milled, platelets, spheres, micro-balloons), recycled polymer composite particles, metals in various forms, metallic oxides or hydroxides (except those that alter shelf life or viscosity), metal hydrides or metal hydrates, carbon particles or granules, alumina, alumina powder, aramid, bronze, carbon black, carbon fiber, cellulose, alpha cellulose, coal (powder), cotton, fibrous glass, graphite, jute, molybdenum, nylon, orlon, rayon, silica amorphous, sisal fibers, fluorocarbons and wood flour.

Preferably, the filler is added in amount between 20 to 65% by weight and more preferably in an amount of 40 to 55% by weight based on the resin composition.

Polymerization inhibitors may also be included in the polymerization mixture such as phenol, 2,6-di-tert-butyl-4-methyl phenol, hydroquinone (HQ), tolu-hydroquinone (THQ), bisphenol “A” (BPA), naphthoquinone (NQ), p-benzoquinone (p-BQ), butylated hydroxy toluene (BHT), hydroquinone monomethyl ether (HQMME), 4-ethoxyphenol, 4-propoxyphenol, and propyl isomers thereof, monotertiary butyl hydroquinone (MTBHQ), ditertiary butyl hydroquinone (DTBHQ), tertiary butyl catechol (TBC), 1,2-dihydroxybenzene, 2,5-dichlorohydroquinone, 2-acetylhydroquinone, 1,4-dimercaptobenzene, 4-aminophenol, 2,3,5-trimethylhydroquinone, 2-aminophenol, 2-N,N,-dimethylaminophenol, catechol, 2,3-dihrydroxyacetrophenone, pyrogallol, 2-methylthiophenol. Other substituted and un-substituted phenols and mixtures of the above.

Other polymerization inhibitors include stable hindered nitrxyl compounds having the structural formula: 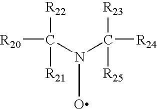
where R₂₀, R₂₁, R₂₅ and R₂₄ are the same or different straight chain or branch substituted or unsubstituted alkyl groups of a chain length. R₂₃ and R₂₄ are independently selected from the group consisting of halogen, cyano, COOR₂₀, —S—COR₂₀, —OCOR₂₀, amido, —S—C₆H₅, carbonyl, alkenyl, or alkyl of 1 to 15 carbon atoms, or may be part of a cyclic structure which may be fused with it another saturated or aromatic ring. In a particular embodiment, the stable hindered nitroxyl compound has the structural formula: 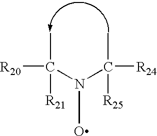
where R₂₀ and R₂₄ are independently selected from the group consisting of hydrogen, alkyl, and heteroatom-substituted alkyl and R₂₁ and R₂₅, are independently selected from the group consisting of alkyl heteroatom-substituted alkyl, and the 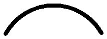
portion represents the atoms necessary to form a five-, six-, or seven member ring heterocyclic ring. Accordingly one of the several classes of cyclic nitroxides that can be employed in the practice of the present invention can be presented by the following structural formula: 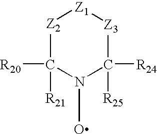
wherein Z₁, Z₂ and Z₃ are independently selected from the group consisting of oxygen, sulfur, secondary amines, tertiary amines, phosphorus of various oxidation states, and substituted and unsubstituted carbon atoms, such as >CH₂, >CHCH₃, >C═O, >C(CH₃)₂, >CHBr, >CHCl, >CHI, >CHF, >CHOH, >CHCN, >CH(OH)CN, >CHCOOH, >CHCOOCH₃, >CHC₂H₅, >C(OH)COOC₂H₅, >C(OH)COOCH₃, >C(OH)CH(OH)C₂H₅, >CR₂₀OR₂₁, >CHNR₂₀R₂₁, >CCONR₂₀R₂₁, >C═NOH, >C═CH—C₆H₅, >CF₂, >CCl₂, >CBr₂, >Cl₂, and the like. Additional useful stable hindered nitrxyl inhibitors are described on patent publications WO 01/40404 A1, WO01/40149 A2, WO 01/42313 A1, U.S. Pat. No. 4,141,883, U.S. Pat. No. 6,200,460 B1, U.S. Pat. No. 5,728,872, incorporated here in their entirety.

Other inhibitors that may be used include oxime compounds of the following formula: 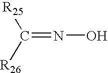
where R₂₅ and R₂₆ are the same or different and are hydrogen, alkyl, aryl, arakyl, alkylhydroxyaryl or arylhydronyalkyl groups having three to about 20 carbon atoms. Those of skill in the art will find valuable advice for choosing these components in international patent WO 98/14416.

The copolymers in accordance with the invention can be used individually or as a mixture, where the term mixture is to be understood broadly. It includes both mixtures of different copolymers of this invention as well as mixtures of copolymers prepared by condensation, addition polymerization and radical polymerization, such polymers include: saturated polyester resins (e.g., resins employed in hot melt adhesives, low profile agents and powder coatings), unsaturated polyesters (e.g., resins used in forming molded articles), aliphatic and aromatic polyethers, vinyl ester resins (e.g., resins used in filament winding and open and closed molding), polyurethanes, styrenic resins, acrylic resins, butadiene resins, and mixtures of any of the above.

Additional additives include phenolic type antioxidants as those described in pages 1 to 104 in “Plastic additives”, by R. Gächter and Müller, Hanser Publishers, 1990. Included also are Mannich type antioxidants, especially phenols and naphthols, suitable for the purposes herein, including hindered aromatic alcohols, such as hindered phenols and naphthols, for example, those described in U.S. Pat. No. 4,324,717, the disclosure of which is incorporated herein by reference in its entirety.

Various hydroxyl and carboxyl terminated rubbers may be also used as toughening agents. Examples of such materials are presented in U.S. Pat. No. 4,100,229, the disclosure of which is incorporated by reference herein in its entirety; and in J. P. Kennedy, in J. Macromol. Sci. Chem. A21, pp. 929(1984). Such rubbers include, for example, carbonyl-terminated and hydroxyl polydienes. Exemplary carbonyl-terminated polydienes are commercially available from BF Goodrich of Cleveland, Ohio, under the trade name of Hycar™. Exemplary hydroxyl-terminated Polydienes are commercially available from Atochem, Inc., of Malvern, Pa., and Shell Chemical of Houston, Tex.

Various polyethoxylated and polypropoxylated hydroxyl terminated polyethers derived from alcohols, phenols (including alkyl phenols), and carboxylic acids can be used as toughening agents. Alcohols which may be used in forming these materials include, but are not limited to, tridecyl alcohol, lauryl alcohol, oleyl alcohol, and mixtures thereof. Commercially suitable polyethoxylated and polypropoxylated oleyl alcohol are sold under the trade name of Rhodasurf™ by Rhone-Poulenc of Cranbury, N.J., along with Trycol™ by Emery Industries of Cincinnati, Ohio. Examples of phenols and alkyl phenols which may be used include, but are not limited to, octyl phenol, nonyl phenol, tristyrylphenol, and mixtures thereof. Commercially suitable tristyrylphenols include, but are not limited to, Igepal™ by Rhone-Poulenc, along with Triton™ by Rohm and Haas of Philadelphia, Pa.

The laminating resin composition may include an agent such as an organic peroxide compound to facilitate curing of the composition. Exemplary organic peroxides may be used and include, for example, cumene hydroperoxide, methyl ethyl ketone peroxide, benzoyl peroxide, acetyl acetone peroxide, 2,5-dimethylhexane-2,5-dihydroperoxide, tert-butyl peroxybenzoate, di-tert-butyl perphthalate, dicumylperoxide, 2,5-dimethyl-2,5-bis(tert-butylperoxy)hexane, 2,5-dimethyl-2,5-bis (tert-butylperoxy) hexyne 3, bis (tert-butylperoxyisopropyl) benzene di-tert-butyl peroxide, 1,1-di (tert-amylperoxy)-cyclohexane, 1,1-di-(tert-butylperoxy)-3,3,5-trymethylcyclohexane, 1,1-di-(tert-butylperoxy)-cyclohexane, 2,2-di-(tert-butylperoxy)-butane, n-butyl 4,4-di-(tert-butylperoxy)-valerate, ethyl 3,3-di-(tert-amylperoxy)-butyrate, ethyl 3,3-di-(tert-butylperoxy)-butyrate and the like. Mixtures of any of the above may be used. The agent is preferably employed in an amount from about 1 to 5 percent based on the weight of the laminating resin, more preferably from about 1 to 3 percent by weight, and most preferably from about 1 to 2 percent by weight.

Suitable curing accelerators or promoters may also be used and include, for example, cobalt naphthanate, cobalt octoate, N,N-diethyl aniline, N,N-dimethyl aniline, N,N-dimethyl acetamide, and N,N-dimethyl p-toluidine. Other salts of lithium, potassium, zirconium, calcium and copper. Mixtures of the above may be used. The curing accelerators or promoters are preferably employed in amounts from about 0.005 to about 1.0 percent by weight, more preferably from about 0.1 to 0.5 percent by weight, and most preferably from about 0.1 to 0.3 percent by weight of the resin.

Additional additives known by the skilled artisan may be employed in the laminating resin composition of the present invention including, for example, thixotropic agents, paraffins, fatty acids, fatty acid derivatives, lubricants, and shrink-reducing additives. Various percentages of these additives can be used in the laminating resin composition.

According to other embodiments, the invention relates to an article of manufacture. The article of manufacture may be a product which employs a laminating resin, and typically includes marine vessels, vehicles, tub shower and aircraft. More specifically, the article includes a substrate with the laminating resin composition coated thereon. The substrate may be made of any appropriate material and typically includes fibrous reinforced material such as those formed of thermoset or thermoplastic resins. The fibers which may be used typically include, but are not limited to, fibrous glass, carbon fibers, aromatic polyamide fibers, inorganic fibers, and the like. The substrate may also be an acrylic containing thermoplastic material.

In other embodiments, the invention relates to a method of forming an article of manufacture. The method comprises applying a laminating resin composition, a thermoplastic substrate (e.g., an acrylic or ABS thermoplastic sheet) to form an article of manufacture. The laminating resin composition may contain a fibrous reinforcement and/or filler as described herein. The laminating resin composition may be applied to the substrate by a suitable method such as coating (e.g., spraying, roll coating, infusion or brushing) to the substrate so as to form a coat. The processing conditions for applying the laminating resin composition along with the resulting thickness of the resin on the substrate may be selected according to its desired use.

The following examples are provided to illustrate some embodiments of the present invention, and should not be construed as limiting thereof.

### EXAMPLE 1

0.8 moles of 2-methyl 1, 3 propanediol (MPD), 0.35 moles of proplylene glycol (PG), 0.45 moles of maleic anhydride (MA), 0.55 moles of orthophthalic anhydride (PA) and 0.1 moles of benzoic acid (BA) were charged to a 5 liter, 4 necked flask equipped with a heating mantle, stirrer, thermometer, inert gas inlet tube, and a fractionating column. A still head with thermometer and take off condenser was mounted on the top of the fractionating column. The temperature of the reaction mixture was raised gradually to 180° C. and held for 2 hours. 0.06 moles of 2 ethyl hexanol (2EH) was added and then the temperature was gradually raised to 210° C. The reaction was continued to an acid value of below 30 at 75% non volatiles in styrene monomer. The temperature of the distilling vapors at the top of the column was maintained below 100° C. The Gardner viscosity of the resin was L-M.

### EXAMPLES 2-5

Examples 2-5 represent various homogeneous resins described in Example 1. The amounts listed in Table 1 are on a mole basis.

TABLE 1

| Ingredients | Example 2 | Example 3 | Example 4 | Example 5 |
|---|---|---|---|---|
| MPD | | 80 | 80 | |
| PG | 115 | 35 | 35 | 109 |
| PA | 55 | 42 | 42 | 55 |
| MA | 45 | 55 | 55 | 45 |
| BA | | 6 | 6 | |
| 2EH | 12 | | 10 | 12 |
| Caprolactam | | 10 | | |

### EXAMPLE 6

A dicylcopentadiene (DCPD) resin, Polylite® 44285-00, available from Reichhold Inc. of Durham, N.C., was prepared from 2.0 moles of maleic anhydride, 2.0 moles of DCPD and 1.0 moles of diethylene glycol.

### EXAMPLE 7

A dicylcopentadiene (DCPD) resin, Polylite® 44006-00, available from Reichhold Inc. of Durham, N.C., was prepared from 2.0 moles of maleic anhydride, 2.0 moles of DCPD and 0.8 moles of ethylene glycol and 0.4 moles of diethylene glycol.

### EXAMPLE 8

A urethane acrylate resin, 16060-00, available from Reichhold Inc. was prepared from 1 moles of polytetramethylene ether glycol, 2 moles of isophorone diisocyanate and 2 moles of hydroxyethyl acrylate.

### EXAMPLES 9-15

Examples 9-15 represent various homogeneous polymer solutions of the invention formed from resins described in Examples 1-8. The compositions and properties of Examples 9-15 are shown in Tables 2 and 3. The amounts listed are on a parts per hundred polymer dry weight basis. To the resins were added 0.21 wt % of 12 wt % cobalt solution, 0.2 wt % of dimethylacetoacetamide as promoters, 0.3 wt % of clay and 0.025 wt % of BYK R605 as thixtropic agents, 0.25 wt % of ethoxyl octyl phenol as wetting agents, 0.15 wt % of BYK A555 as air releasing agent and 0.01-0.03 wt % of additional inhibitors such as toluhydroquinone and parabenzoquinone to adjust gel time to 10-25 minutes suitable for spray up applications. The total amount of styrene in Examples 9-15 are listed in table 3. The resins were then filled with 55% weight calcium sulfate, 1.25% weight of methyl ethyl ketone peroxide was added, a laminate comprising of 15% weight 2 Ply of 1.5 oz. chopped strand mat glass was then made on top of acrylic sheets. The laminate was cured in 1 hour and further conditioned at room temperature for 2 days. The tensile adhesion results were obtained by ASTM C297 and appear in Table 3. Clear resin castings were made by pouring pre-promoted resins between two glass plates measuring 12 by 12 inches and spaced with 0.125 inch metal shims. The castings were allowed to cure at room temperature overnight and were then post-cured for 2 hours at 150° F. and 2 hours at 250° F., results are listed in Table 4.

TABLE 2

| | Exam- | Exam- | Exam- | Exam- | | |
|---|---|---|---|---|---|---|
| Example # | ple 1 | ple 4 | ple 5 | ple 6 | Example 7 | Example 8 |
| 9 | 100 | | | | | |
| 10 | 100 | | | | | 2 |
| 11 | 50 | | | 50 | | 0 |
| 12 | 49 | | | 49 | | 2 |
| 13 | 48.5 | | | 48.5 | | 3 |
| 14 | | 49 | | | 49 | 1 |
| 15 | | | 49 | 49 | | 2 |

TABLE 3

| | | Styrene | Tensile adhesion | Tensile adhesion |
|---|---|---|---|---|
| | Viscosity | Content | to acrylic | to ABS sheet |
| Example # | (cps) | (wt %) | sheet (psi) | (psi) |
| 9 | 3750 | 35 | 707 | — |
| 10 | 4120 | 35 | 800 | — |
| 11 | 2550 | 35 | 1002 | — |
| 12 | 2580 | 35 | 1287 | — |
| 13 | 2580 | 35 | 1359 | — |
| 14 | 1720 | 35 | 1500 | 1577 |
| 15 | 1600 | 40 | 1490 | 1497 |

TABLE 4

| | Tensile | Tensile | Flexural | Flexural | | |
|---|---|---|---|---|---|---|
| | Strength | Modulus | Strength | Modulus | Elongation | HDT |
| Example # | psi | kpsi | psi | kpsi | (%) | (C.) |
| 9 | 3125 | 206 | 3725 | 79 | 17.7 | 41 |
| 14 | 6000 | 405 | 12290 | 422 | 1.8 | 57 |
| 15 | 7400 | 549 | 126700 | 577 | 1.7 | 68 |

There have been disclosed typical embodiments of the invention and, although specific terms are employed, they are used in a generic and descriptive sense only and not for purposes of limitation. The following claims are provided to ensure that the present application meets all statutory requirements as a priority application in all jurisdictions and shall not be construed as setting forth the full scope of the present invention.

1. A thermosetting resin composition comprising:
a) an orthophthalic unsaturated polyester resin;
b) a dicyclopentadiene resin; and
c) a polyether urethane acrylate having two or more acrylate functionality per molecule.

2. The thermosetting resin composition according to claim 1 further comprising an ethylenically unsaturated monomer.

3. The thermosetting resin composition according to claim 1, wherein said polyether urethane acrylate has a functionality of from 2 to 4.

4. The thermosetting resin composition according to claim 1, further comprising a filler.

5. The thermosetting resin composition according to claim 1, further comprising a polymerization inhibitor.

6. The thermosetting resin composition according to claim 1, further comprising an antioxidant.

7. A thermosetting resin composition comprising:
a) 10 to 80 percent by weight of a chain-stopped orthophthalic unsaturated polyester resin;
b) 10 to 80 percent by weight of a dicyclopentadiene resin;
c) 0.5 to 10 percent by weight of a polyether urethane acrylate having two or more acrylate functionality per molecule; and
d) 0 to 40 percent by weight of an ethylenically unsaturated monomer.

8. The thermosetting resin composition according to claim 7, wherein said polyether urethane acrylate has a functionality of from 2 to 4.

9. The thermosetting resin composition according to claim 7 further comprising 20 to 65 percent by weight filler.

10. A laminated article of manufacture comprising:
a) a thermoplastic substrate; and
b) a laminating resin composition applied to said substrate and comprising an orthophthalic unsaturated polyester resin; a dicyclopentadiene resin; and a polyether urethane acrylate having two or more acrylate functionality per molecule.

11. The article of manufacture according to claim 10, wherein the substrate is an acrylic or ABS thermoplastic substrate.

12. The article of manufacture according to claim 10, wherein the article has a tensile adhesion of greater than about 1300 psi.

13. An article of manufacture according to claim 11 further comprising an ethylenically unsaturated monomer.

14. An article of manufacture according to claim 11, wherein said polyether urethane acrylate has a functionality of from 2 to 4.

15. An article of manufacture according to claim 11, further comprising a filler.

16. An article of manufacture according to claim 11, further comprising a polymerization inhibitor.

17. An article of manufacture according to claim 11, further comprising an antioxidant.
